(19) United States
(12) Patent Application Publication
(10) Pub. No.: US 2020/0342065 A1
(43) Pub. Date: Oct. 29, 2020

(54) REPLICATING USER CREATED SNAPSHOTS

(71) Applicant: EMC Corporation, Hopkinton, MA (US)

(72) Inventors: Xiangping Chen, Sherborn, MA (US); David Meiri, Cambridge, MA (US)

(21) Appl. No.: 14/982,976

(22) Filed: Dec. 29, 2015

(51) Int. Cl. G06F 17/30; H04L 29/08

(52) U.S. Cl. CPC G06F 17/30575; H04L 67/1095

(57) ABSTRACT

A system, computer program product, and computer-executable method of replicating user initiated snapshots created in a distributed system and enabled to be replicated to a remote system, wherein the remote system includes a snapshot tree, the c system, computer program product, and computer-executable method including receiving a request to replicate a first snapshot, determining whether the distributed system is currently replicating a second snapshot, and processing the first snapshot based on the determination.

A portion of the disclosure of this patent document may contain command formats and other computer language listings, all of which are subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to data storage.

### BACKGROUND

Computer systems are constantly improving in terms of speed, reliability, and processing capability. As is known in the art, computer systems which process and store large amounts of data typically include a one or more processors in communication with a shared data storage system in which the data is stored. The data storage system may include one or more storage devices, usually of a fairly robust nature and useful for storage spanning various temporal requirements, e.g., disk drives. The one or more processors perform their respective operations using the storage system. Mass storage systems (MSS) typically include an array of a plurality of disks with on-board intelligent and communications electronics and software for making the data on the disks available.

Companies that sell data storage systems and the like are very concerned with providing customers with an efficient data storage solution that minimizes cost while meeting customer data storage needs. It would be beneficial for such companies to have a way for reducing the complexity of implementing data storage.

### SUMMARY

A system, computer program product, and computer-executable method of replicating user initiated snapshots created in a distributed system and enabled to be replicated to a remote system, wherein the remote system includes a snapshot tree, the c system, computer program product, and computer-executable method including receiving a request to replicate a first snapshot, determining whether the distributed system is currently replicating a second snapshot, and processing the first snapshot based on the determination.

### BRIEF DESCRIPTION OF THE DRAWINGS

Objects, features, and advantages of embodiments disclosed herein may be better understood by referring to the following description in conjunction with the accompanying drawings. The drawings are not meant to limit the scope of the claims included herewith. For clarity, not every element may be labeled in every figure. The drawings are not necessarily to scale, emphasis instead being placed upon illustrating embodiments, principles, and concepts. Thus, features and advantages of the present disclosure will become more apparent from the following detailed description of exemplary embodiments thereof taken in conjunction with the accompanying drawings in which:

FIG. 1 is a simplified illustration of a distributed system replicating to a remote system, in accordance with an embodiment of the present disclosure;

FIGS. 2A-2H are state diagrams of the hierarchical snapshot tree described in FIG. 1, in accordance with an embodiment of the present disclosure;

FIG. 3 is a simplified flowchart of a method of asynchronously managing replication cycles in a distributed system as shown in FIG. 1, in accordance with an embodiment of the present disclosure;

FIG. 4 is a simplified illustration of a data storage system replicating user initiated snapshot replication between a distributed system and a remote system, in accordance with an embodiment of the present disclosure;

FIGS. 5A and 5B are state diagrams of a hierarchal snapshot tree within a remote system shown in FIG. 4, in accordance with an embodiment of the present disclosure;

FIGS. 6A and 6B are state diagrams of a hierarchal snapshot tree within a remote system shown in FIG. 4, in accordance with an embodiment of the present disclosure;

FIGS. 7A and 7B are state diagrams of a hierarchal snapshot tree within a remote system shown in FIG. 4, in accordance with an embodiment of the present disclosure;

FIG. 8 is a simplified flowchart of a method of replication of user initiated snapshots, in accordance with an embodiment of the present disclosure;

FIG. 9 is an alternate simplified flowchart of a method of replication of user initiated snapshots, in accordance with an embodiment of the present disclosure;

FIG. 10 is an example of an embodiment of an apparatus that may utilize the techniques described herein, in accordance with an embodiment of the present disclosure; and

FIG. 11 is an example of a method embodied on a computer readable storage medium that may utilize the techniques described herein, in accordance with an embodiment of the present disclosure.

Like reference symbols in the various drawings indicate like elements.

### DETAILED DESCRIPTION

Traditionally, many distributed systems use a consistent snapshot mechanism to replicate data between a source site and a remote site. Typically, distributed systems are enabled to replicate snapshots between the distributed systems and remote systems. However, generally, consistent snapshot mechanisms differentiate between system initiated snapshot replication and user initiated snapshot replication causing adding complications, layers, and/or additional space to address a user's request to replicate one or more snapshots. Conventionally, improvements to replication using a consistent snapshot mechanism would be beneficial to the data storage industry.

Typically, a snapshot is created from data within a distributed system from one or more sources at the beginning of a replication cycle. Generally, once the data changes, those changes are transferred to a remote site. Conventionally, upon completion of the data transfer, a snapshot is created at the remote site which contains the same data as the snapshot(s) resident at the source site(s), thereby completing a replication cycle. Traditionally, a distributed system separates replication of system created snapshots and user initiated snapshots. Typically, a distributed system replicates a user initiated snapshot as a single snapshot unrelated to other snapshots that may be been replicated to a remote site. Conventionally, separate methods of replication can cause an unnecessary amount of data to be transferred when a distributed system replicates a user initiated snapshot.

In many embodiments, the current disclosure may enable a data storage system to manage user created snapshots alongside system created snapshots. In various embodiments, a data storage system may include a distributed system and a remote system to which the distributed system may be enabled to replicate. In certain embodiments, a remote system may be enabled to manage and/or store system initiated and/or user initiated snapshot replication using the same snapshot tree. In some embodiments, the current disclosure may enable a distributed system to replicate a user initiated snapshot without replicating the entire snapshot. In most embodiments, the current disclosure may enable a distributed system to treat system initiated and/or user initiated snapshot replication similarly.

### Snapshot Mechanism

The present embodiments relate in one aspect to a snapshot of a thinly provisioned volume or other logical data construct, which snapshot comprises metadata relating to changed parts of the address range only in relation to an ancestor, and is thus in itself only thinly provisioned. The snapshot may be part of a hierarchy of snapshots wherein the metadata for a given location may be placed at the point in which it first appears in the hierarchy and which metadata is pointed to by later snapshots.

According to an aspect of some embodiments of the present invention there is provided a memory management system for a memory volume, the system comprising a snapshot provision unit configured to take a given snapshot of the memory volume at a given time, the snapshot comprising a mapping table and memory values of the volume, the mapping table and memory values comprising entries for addresses of the physical memory containing data, which values entered differ from an ancestor of the snapshot.

In an embodiment, the volume is a thinly provisioned memory volume in which a relatively larger virtual address range of virtual address blocks is mapped to a relatively smaller physical memory comprising physical memory blocks via a mapping table containing entries only for addresses of the physical memory blocks containing data.

In an embodiment, the given snapshot is part of a hierarchy of snapshots taken at succeeding times, and wherein the snapshot provision unit is configured to provide the entries to the given snapshot for addresses of the physical memory to which data was entered subsequent to taking of a most recent previous snapshot in the hierarchy, and to provide to the given snapshot pointers to previous snapshots in the hierarchy for data entered prior to taking of a most recent previous snapshot.

In an embodiment, the snapshot provision unit is configured to create a read-only version of the thinly provisioned memory volume to provide a fixed base for the hierarchy.

In an embodiment, the snapshot provision unit is configured to provide a first tree structure of the hierarchy to indicate for each written memory block a most recent ancestor snapshot of a queried snapshot containing a respective entry.

In an embodiment, the snapshot provision unit comprises a read function which traverses the first tree structure to read a value of a given block, and a write function which writes a block value to a most recent snapshot in the hierarchy.

In an embodiment, the snapshot provision function is configured to provide a second tree structure, the second tree structure indicating, for each written memory block, which level of the hierarchy contains a value for the block.

In an embodiment, the snapshot provision unit comprises a read function configured to traverse the second memory structure to find a level of the hierarchy containing a value for a requested block and then to use the first memory structure to determine whether the level containing the value is an ancestor in the hierarchy of a level from which the block was requested.

In an embodiment, the snapshot provision unit further comprises a delete function for deleting snapshots, wherein for a snapshot to be deleted which has a single sibling, values of sibling and parent nodes are merged into a single node.

In an embodiment, the physical memory comprises random access memory disks.

In an embodiment, the blocks are of a granularity of one member of the group consisting of less than 100k, less than 10k and 4k.

In an embodiment, the snapshot provision unit is configured to align mapping data of a respective snapshot to a page of memory.

In an embodiment, the snapshot provision unit is configured to provide a third tree structure, the third tree structure returning a Depth-First Search ordering of respective snapshots of the hierarchy, such that leaves of each snapshot are ordered consecutively and that if a snapshot A is an ancestor of a snapshot B then the ordering of leaves of A completely overlaps that of B.

In an embodiment, the snapshot provisioning unit is configured with a read function, the read function configured to use the third tree structure to obtain a list of snapshots having a value at a requested memory address, and to find a closest ancestor in the list of a requesting snapshot by traversing the snapshots of the list and returning a respective snapshot of the list which is an ancestor of the requesting snapshot and has a minimum number of leaves.

In an embodiment, the snapshot provision unit is configured to provide an indirection layer or a look-aside table to provide data deduplication.

According to a second aspect of the present invention there is provided a memory management method comprising taking a given snapshot of a memory volume at a given time, providing the snapshot with a mapping table and memory values of the volume, the mapping table and memory values comprising entries for addresses of the physical memory containing data, and wherein the values differ from data in an ancestor.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

More information regarding snapshot mechanisms may be found in U.S. patent application Ser. No. 13/470,317 entitled “Snapshot Mechanism” which is commonly assigned herewith and incorporated by reference herein.

### Hash-Based Replication

In a Content Addressable Storage (CAS) array, data is stored in blocks, for example of 4 KB, where each block has a unique large hash signature, for example of 20 bytes, saved on Flash memory. As described herein, hash signatures are accessed by small in-memory handles (Called herein short hash handles), for example of 5 bytes. These handles are unique to each array, but not necessarily unique across arrays. When replicating between two CAS arrays, it is much more efficient to use hash signatures instead of sending the full block. If the target already has the data block corresponding to the hash signature, there is no need to send the corresponding data. However, reading the hash signatures may be expensive, and is wasteful if the target does not have the data (in this case it is faster to send the data without a hash signature, and let the target calculate the hash signature.) While the short hash handles are readily available without the need to read from Flash, since the short hash handles are not unique, they cannot be easily used to check if a target contains a hash signature. In some implementations, short hash handles are shortcuts for hash signatures, and can give a reliable hint of the existence of a hash signature in an array. Described herein is an approach to use these short hash handles, verify them through the hash signature, and send the data as needed. While the description describes using this approach with de-duplication storage devices, it would be appreciated by one of ordinary skill in the art that the approach described herein may be used with any type of storage device including those that do not use de-duplication.

The examples described herein include a networked memory system. The networked memory system includes multiple memory storage units arranged for content addressable storage of data. The data is transferred to and from the storage units using separate data and control planes. Hashing is used for the content addressing, and the hashing produces evenly distributed results over the allowed input range. The hashing defines the physical addresses so that data storage makes even use of the system resources.

A relatively small granularity may be used, for example with a page size of 4 KB, although smaller or larger block sizes may be selected at the discretion of the skilled person. This enables the device to detach the incoming user access pattern from the internal access pattern. That is to say the incoming user access pattern may be larger than the 4 KB or other system-determined page size and may thus be converted to a plurality of write operations within the system, each one separately hashed and separately stored.

Content addressable data storage can be used to ensure that data appearing twice is stored at the same location. Hence unnecessary duplicate write operations can be identified and avoided. Such a feature may be included in the present system as data deduplication. As well as making the system more efficient overall, it also increases the lifetime of those storage units that are limited by the number of write/erase operations.

The separation of Control and Data may enable a substantially unlimited level of scalability, since control operations can be split over any number of processing elements, and data operations can be split over any number of data storage elements. This allows scalability in both capacity and performance, and may thus permit an operation to be effectively balanced between the different modules and nodes.

The separation may also help to speed the operation of the system. That is to say it may speed up Writes and Reads. Such may be due to:

(a) Parallel operation of certain Control and Data actions over multiple Nodes/Modules

(b) Use of optimal internal communication/networking technologies per the type of operation (Control or Data), designed to minimize the latency (delay) and maximize the throughput of each type of operation.

Also, separation of control and data paths may allow each Control or Data information unit to travel within the system between Nodes or Modules in the optimal way, meaning only to where it is needed and if/when it is needed. The set of optimal where and when coordinates is not the same for control and data units, and hence the separation of paths ensures the optimization of such data and control movements, in a way which is not otherwise possible. The separation is important in keeping the workloads and internal communications at the minimum necessary, and may translate into increased optimization of performance.

De-duplication of data, meaning ensuring that the same data is not stored twice in different places, is an inherent effect of using Content-Based mapping of data to D-Modules and within D-Modules.

Scalability is inherent to the architecture. Nothing in the architecture limits the number of the different R, C, D, and H modules which are described further herein. Hence any number of such modules can be assembled. The more modules added, the higher the performance of the system becomes and the larger the capacity it can handle. Hence scalability of performance and capacity is achieved.

More information regarding Hash-Based Replication may be found in U.S. patent application Ser. No. 14/037,577 entitled “Hash-Based Replication” which is commonly assigned herewith and incorporated by reference herein.

### Asynchronous Replication Cycles

In many embodiments, the current disclosure may enable a distributed system to initiate a subsequent replication of one or more source sites to a remote site which one or more replication cycles are contemporaneously being executed. In various embodiments, the current disclosure may enable a device within a distributed system to move forward to a subsequent replication cycle before a current replication cycle completes. In most embodiments, the current disclosure may enable replication of multiple devices into one consistency group (fan-in configuration). In various embodiments, devices in a fan-in configuration may be enabled to allow one or more applications to replicate to a single remote site with a single consistency group containing data for each application.

In most embodiments, the current disclosure may enable a distributed system to support asynchronous snapshot based remote replication. In many embodiments, Asynchronous snapshot based remote replication may provide data protection against site disaster with minimal impact to host IO performance. In various embodiments, asynchronous snapshot based remote replication may work by creating snapshots, calculating differences between a snapshot and a previous snapshot, periodically transferring differences to a remote site, and reconstructing data content at the remote sites.

In many embodiments, a data storage system may be enabled to be configured to execute asynchronous snapshots without user intervention. In certain embodiments, a replication cycle in a distributed system may involve data transfers engaging multiple devices. In most embodiments, the current disclosure may enable a distributed system to leverage snapshot tree technology and may enable parallel pipeline replication cycles. In various embodiments, a distributed system may be enabled to start a subsequent replication cycle without waiting for a previous replication cycle to complete. In certain embodiments, data consistency may be limited to the latest completed replication cycle, however, the distributed system may be enabled to continue replication and/or data transfer upon completion of localized operations. In some embodiments, the current disclosure may enable more efficient use of resources and reduce resource shortage/contention, which may greatly speed up the replication recovery time once system resources return to normal.

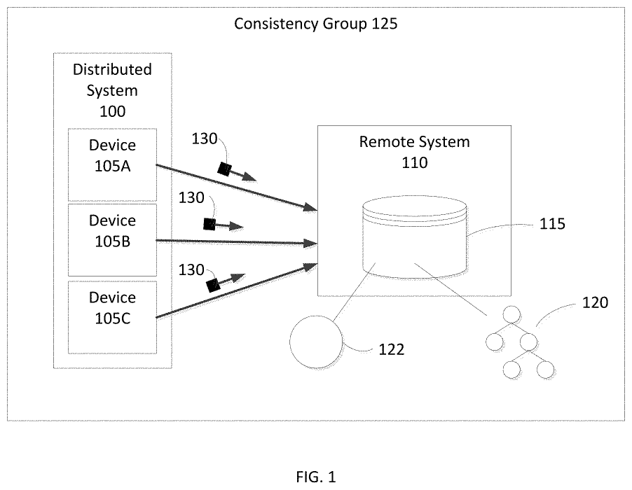

Refer to the example embodiment of FIG. 1. FIG. 1 is a simplified illustration of a distributed system replicating to a remote system, in accordance with an embodiment of the present disclosure. consistency group 125 includes distributed system 100 and remote system 110. Distributed system 100 includes devices (105A-C, 105 Generally). In this embodiment, devices 105 within distributed system 100 are replicating to data storage 115 within remote system 110. Remote system 110 manages snapshot replication by utilizing a hierarchical snapshot tree 120 to store replication cycles of distributed system 100. Remote system 110 is enabled to asynchronously handle one or more replication cycles from distributed system 100. Once a replication cycle has been completed, remote system 110 is enabled to provide snapshot volume 122 which is enabled to be read from and written to by distributed system 100.

In this embodiment, each device 105 is enabled to send difference data at a Point in Time (PiT) since the last snapshot was taken and send the difference data to remote system 110 using messages 130. Remote system 110 is enabled to receive difference data in message 130 and build hierarchical snapshot tree 120 to manage each replication cycle. As each replication cycle ends, remote system 110 is enabled to provide access to the latest consistent snapshot received from distributed system 100. Remote system 110 is enabled to receive difference data from multiple replication cycles simultaneously. Remote system 110 is enabled to place multiple replication cycles into hierarchical snapshot tree 120 as needed.

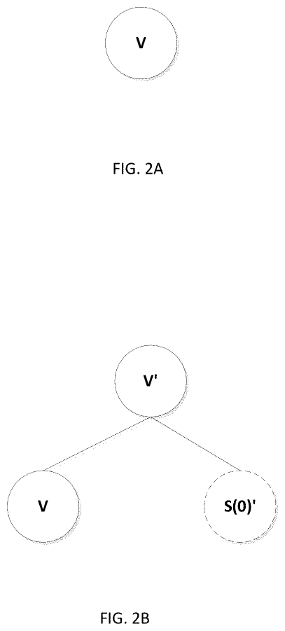

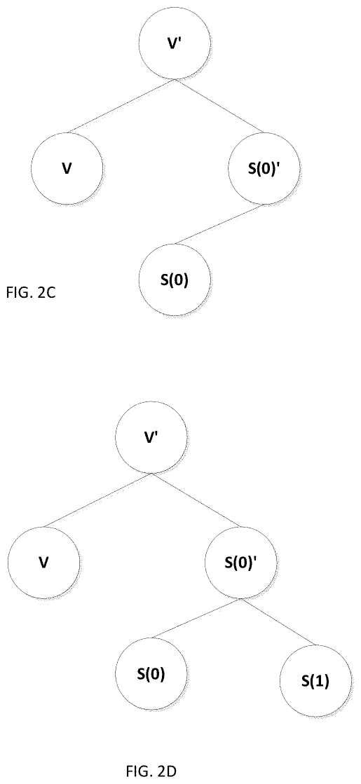

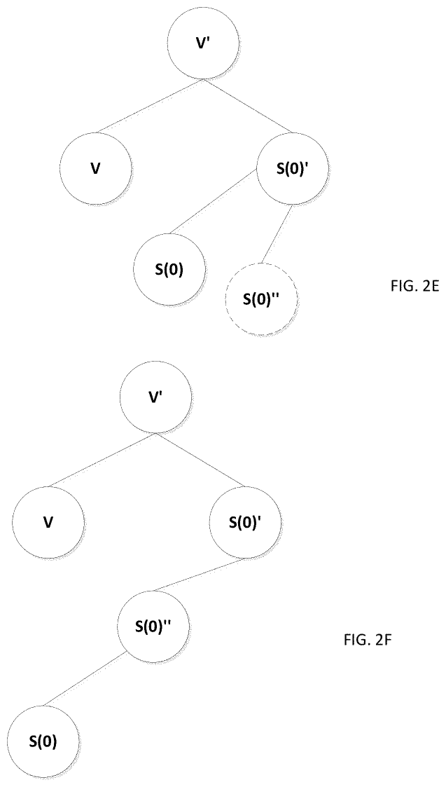

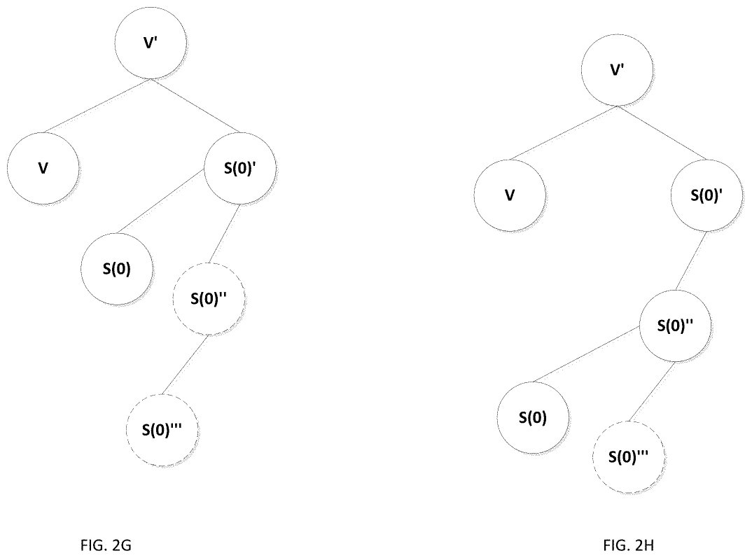

Refer to the example embodiments of FIGS. 2A-2H. FIGS. 2A-2H are state diagrams of the hierarchical snapshot tree described in FIG. 1, in accordance with an embodiment of the present disclosure. FIG. 2A shows the initial state of data storage on Remote system 110 (FIG. 1). V is the total amount of data on Remote system 110. Upon starting replication in FIG. 2B, Distributed System 100 (FIG. 1) starts by creating a baseline snapshot “S(0)′”.

FIG. 2B shows a second state of data storage on Remote System 110. As shown in 2B, Remote System 110 creates a read only snapshot “V′” and a read/writable active snapshot “V” while snapshot “S(0)′” is being created.

FIG. 2C shows a third state of data storage on Remote System 110. In this embodiment, Snapshot “S(0)′” has been completed and is set to read only. Remote system 110 (FIG. 1) creates Active Snapshot “S(0)” which is a read/writable snapshot showing the latest consistent data on remote system 110.

FIG. 2D is a forth state of data storage on Remote System 110. Remote system 110 (FIG. 1) has created read/writable snapshot “S(1)” which is based on snapshot “S(0)′”. In many embodiments, a Remote system may be enabled to provide one or more read/writable snapshots based on any consistent snapshot stored within the remote system. In various embodiments, one or more snapshots of a specific replication cycle may be required by one or more devices within the distributed system.

FIG. 2E is a fifth state of data storage on Remote System 110 (FIG. 1). In this embodiment, hierarchical snapshot tree 120 (FIG. 1) includes V, V′, S(0)′, and S(0). As shown, remote system 110 has received a request to create another snapshot “S(0)″” which depends from S(0)′ and V′ within hierarchical snapshot tree 120. Remote system 110 maintains S(0) as the active snapshot of consistency group 125 (FIG. 1) as snapshot S(0)″ has not been completed.

FIG. 2F is a sixth state of data storage on Remote System 110 (FIG. 1). In this embodiment, hierarchical snapshot tree 120 (FIG. 1) includes V, V′, S(0)′, S(0)″ and S(0). As shown, remote system 110 has received completed replication cycles for snapshots S(0)′ and S(0)″. Upon completion of replication cycle for S(0)″, remote system 110 updates the active snapshot of consistency group 125 (FIG. 1), which is S(0), to depend from the latest consistent snapshot from a replication cycle. In this embodiment, the latest consistent snapshot is snapshot S(0)″. As shown, Remote System 110 is enabled to provide one or more read/writable snapshots from each of the snapshots from completed replication cycles. In this case, snapshots may be created based on S(0)′ and S(0)″.

FIG. 2G is a seventh state of data storage on Remote System 110 (FIG. 1). In this embodiment, hierarchical snapshot tree 120 (FIG. 1) includes V, V′, S(0)′, and S(0). S(0)″ and S(0)″′ represent replication cycles which have not been completed. In many embodiments, each portion of a distributed system may independently provide data to a remote system for one or more replication cycles. In some embodiments, one or more devices may complete a first replication cycle before other devices within the distributed system. In certain embodiments, devices that have completed a replication cycle may be enabled to initiate one or more replication cycles if those devices have completed previous replication cycles. As shown, devices 105 (FIG. 1) within distributed system 100 (FIG. 1) have initiated a replication cycle for snapshot S(0)″ and have initiated a replication cycle for snapshot S(0)″′. In this embodiment, Device 105A and device 105B are in process of completing the replication cycle for snapshot S(0)″. Device 105C has completed the replication cycle for snapshot S(0)″ and has initiated a replication cycle for snapshot S(0)″′. In certain embodiments, devices from a distributed system may be enabled to initiate more than two replication cycles simultaneously.

FIG. 2H is an eighth state of data storage on Remote System 110 (FIG. 1). In this embodiment, hierarchical snapshot tree 120 (FIG. 1) includes V, V′, S(0)′, S(0)″, and S(0). Snapshot S(0)″′ is not complete as the replication cycle for snapshot S(0)″′ has not finished. Comparing FIGS. 2G and 2H, FIG. 2H shows that the active snapshot S(0) now depends from snapshot S(0)″ as snapshot S(0)″ is the latest consistent snapshot. In this embodiment, remote system is enabled to provide read/writable volumes based on snapshots from snapshots S(0)′, S(0)″, and V′.

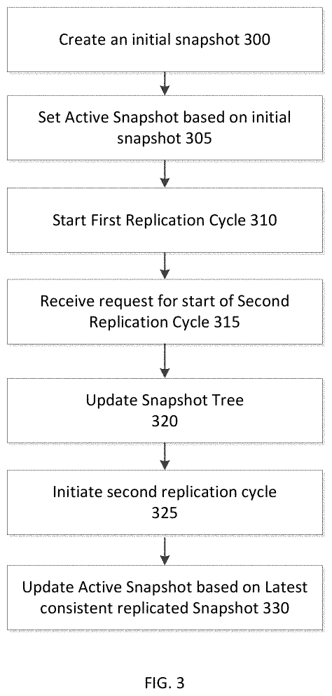

Refer to the example embodiment of FIGS. 1 and 3. FIG. 3 is a simplified flowchart of a method of asynchronously managing replication cycles in a distributed system as shown in FIG. 1, in accordance with an embodiment of the present disclosure. As shown in FIG. 1, Asynchronous replication is conducted using distributed system 100 and remote system 110, distributed system 100 and remote system 110 are in consistency group 125. In various embodiments, a remote system may be enabled to handle data replication from one or more consistency groups. In some embodiments, a remote system may be storing data in relation to two or more replication cycles from two or more consistency groups contemporaneously.

As shown in FIG. 1, distributed system 100 includes device 105A, device 105B, and device 105C. Distributed system 100 is in communication with remote system 110 for the purpose of sending data for replication from distributed system 100 to remote system 110. Remote system 110 includes data storage 115 which is enabled to store hierarchical snapshot tree 120 and make available data storage, such as data volume 122. Upon initializing a replication system, distributed system 100 requests that remote system 110 create an initial snapshot by initiating a replication cycle using devices 105A, 105B, 105C. Devices 105A, 105B, 105C send data differences from a previous snapshot, if a previous snapshot exists), to remote system 110 using messages 130. Remote system 110 creates an initial snapshot on data storage 115 within hierarchical snapshot tree 120 (Step 300). Remote system 110 sets an active snapshot based on the initial snapshot created (Step 305). An active snapshot, commonly called S(0), is a read/writable data volume based on the latest consistent snapshot available within consistency group 125. In this case, the latest consistent snapshot is also the initial snapshot within hierarchical snapshot tree 120.

Upon completion of an initial snapshot, remote system 110 is read for replication cycles to begin. Remote system 110 starts a first replication cycle (Step 310) upon receipt of replication data from distributed system 100. While the first replication cycle is still in process, remote system 110 receives a request for start of a second replication cycle (Step 315). Remote system 110 determines where within hierarchical snapshot tree the second replication cycle should reside and updates the hierarchical snapshot tree (Step 320) to receive data from the second replication cycle. Upon receipt of data related to the second replication cycle, remote system 110 initiates the second replication cycle (Step 325). As each replication cycle completes, remote system 110 updates which snapshot the active snapshot S(0) is based on depending on the latest consistent snapshot (Step 330).

### Replicating User Created Snapshots

In many embodiments, the current disclosure may enable replication of user created snapshots within a data storage system including a distributed system and a remote system. In various embodiments, a data storage system may be enabled to implement asynchronous replication using a distributed system and a remote system. In certain embodiments, a remote system may be enabled to use a hierarchical snapshot tree to manage and/or store replicated snapshots from one or more distributed systems.

In most embodiments, asynchronous replication may work by first establishing a common base between a source and a destination. In various embodiments, during asynchronous replication, a distributed system may periodically transfer incremental data changes to a remote system. In certain embodiments, each side of a replication may be updated with a new common base. In some embodiments, a common base may be a pair of synchronized point in time (PIT) snapshots, one for source and one for destination. In most embodiments, a destination snapshot may include the same data content from a host application point of view. In various embodiments, a first common base may be established via a full sync, where subsequent common bases may be updated via replication cycles where the latest common base may be called an active snapshot.

In most embodiments, for storage array based replication products, once a replication session may be configured, the replication state machine may take care of creating internal PIT snapshots and/or advancing replication cycles without user intervention. In various embodiments, although a user may enjoy hands-off automatic replication, the timing of the system initiated PIT snapshot creation may not be very predictable and/or the timing may not be desirable to a user. In most embodiments, without user and/or application coordination, system initiated PIT snapshots created internally be a replication state machine may only guarantee crash consistency. In various embodiments, a crash consistent volume image may not always be successful in bringing up an application. In certain embodiments, a user may want to replicate an application consistent snapshot to a remote system that may be proven to properly initialize an application when a disaster happens.

Typically, user created snapshots can be replicated to remote systems as a separate volume. However, generally, as snapshot relationships are not maintained, distributed system typically, require a full synchronization of data during replication which results in mapping metadata inflation at a destination (i.e., remote system). Conventionally, older replication techniques complicates disaster recovery, as volume and snapshot relationships need to be tracked using additional configuration metadata.

In many embodiments, the current disclosure may enable a data storage system to replicate between a distributed system and a remote system to leverage a hierarchical snapshot tree. In various embodiments, the current disclosure may enable a user to utilize current snapshot replication mechanisms to replicate a user initiated snapshot. In certain embodiments, a user may be enabled to replicate a snapshot using incremental delta data transfers instead of a complete copy. In most embodiments, a replication engine within a distributed system replicating snapshots may be enabled to assign a future replication cycle to a user initiated snapshot to reduce the overhead of replicating user initiated snapshots.

In many embodiments, a distributed system may include a snapshot replication mechanism. In various embodiments, a snapshot replication mechanism may automatically and/or periodically create snapshots of data stored within one or more devices within a distributed system. In certain embodiments, a snapshot replication mechanism may automatically and/or periodically replicate created snapshots to one or more remote systems. In some embodiments, a distributed system may enable a user to interact and/or configure a snapshot replication mechanism. In most embodiments, a distributed system may enable a user to create snapshots at any user specified time. In various embodiments, a distributed system may enable a user to replicate a created and/or future snapshot to a remote system.

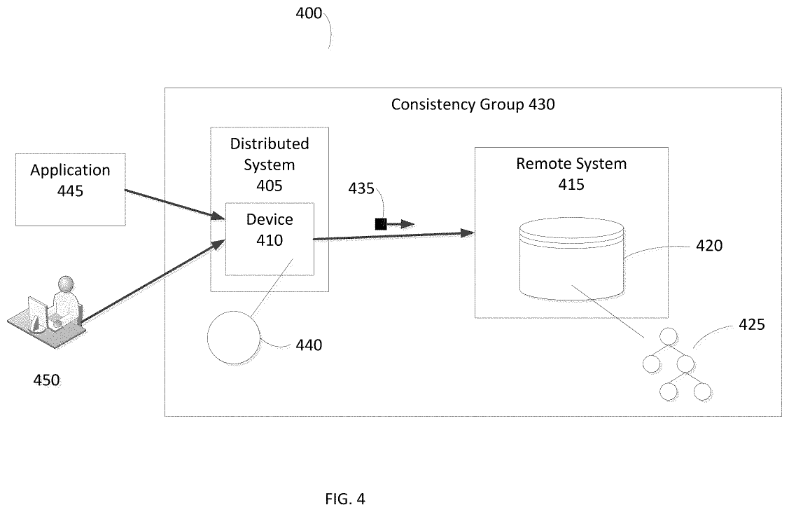

Refer to the example embodiment of FIG. 4. FIG. 4 is a simplified illustration of a data storage system replicating user initiated snapshot replication between a distributed system and a remote system, in accordance with an embodiment of the present disclosure. Data storage system 400 includes distributed system 405 and remote system 415. Distributed system 405 and remote system 415 are in consistency group 430. Distributed system 405 includes device 410. In many embodiments, device 410 may be a deduplicated data storage device enabled to replicate to a remote site and/or remote system. Remote system 415 includes data storage 420 upon which remote system 415 store hierarchal snapshot tree 425. Remote system 415 utilizes hierarchal snapshot tree 425 to manage replicated snapshots received from other devices within consistency group 430. In this embodiment, application 445 is enabled to utilize device 410 on distributed system 405 for data storage, device 410 is enabled to create snapshots of data stored on device 410 as well as replicate snapshots from device 410 to remote system 415 using message 435. As shown, user 450 is enabled to interact with device 410. User 450 is enabled to direct device 410 to create snapshots, replicate one or more specified snapshots, and/or other replication tasks.

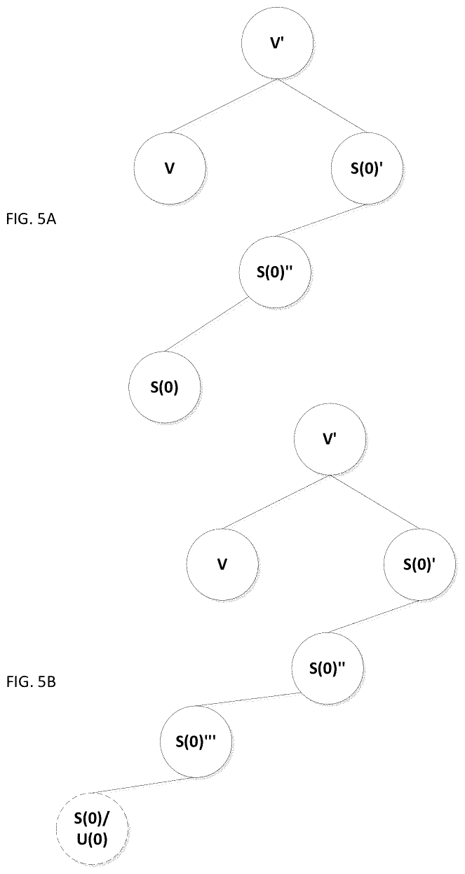

Refer to the example embodiments of FIGS. 4, 5A, and 5B. FIGS. 5A and 5B are state diagrams of a hierarchal snapshot tree within a remote system shown in FIG. 4, in accordance with an embodiment of the present disclosure. FIG. 5A shows a first state of hierarchal snapshot tree 425 within remote system 415. As shown in FIG. 5A, hierarchal snapshot tree 425 includes “V”, which is a read/writable active snapshot and read only snapshot “V′” which includes the base data on the remote system before any replication was initiated. “S(0)′” and “S(0)″” signify replicated snapshots from device 410 which contain delta's from the previous snapshot. For example, as shown in FIG. 5A, active snapshot “S(0)” includes all information from node “S(0)′”, node “S(0)″”, and node “V” within hierarchal snapshot tree 425. Node “S(0)” represents the most recent snapshot, also known as the active snapshot.

FIG. 5B is a second state of hierarchal snapshot tree 425 within remote system 415. In this embodiment, user 450 has requested that device 410 create a user initiated snapshot 440 and replicate snapshot 440 to remote system 415 using message 435. Distributed system 405 is enabled to determine where within hierarchal snapshot tree 425 snapshot 440 is enabled to be placed. In this embodiment, distributed system 405 is enabled to determine that snapshot 440 depends from the active snapshot. Upon receipt of snapshot 440, remote system 415 is enabled to store snapshot 440 within hierarchal snapshot tree 425 within data storage 420. As shown in FIG. 5B, as snapshot 440 was taken after the most recent snapshot replicated, remote system 415 is enabled to place received data in message 435 in node “S(0)/U(0)” which becomes the active snapshot. Node “S(0)/U(0)” depends from node “S(0)″′”.

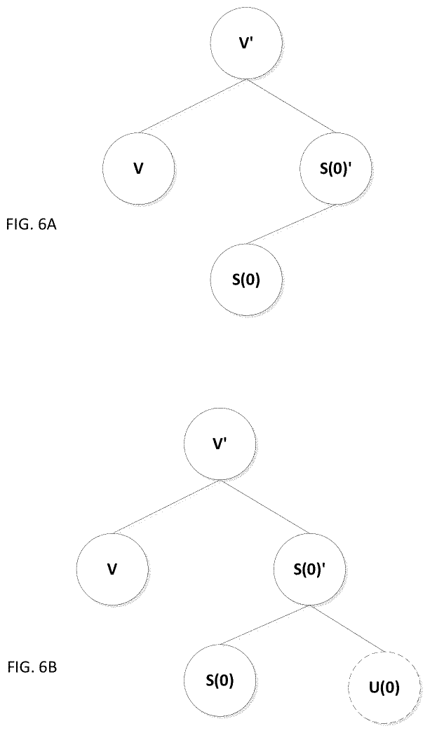

Refer to the example embodiments of FIGS. 4, 6A, and 6B. FIGS. 6A and 6B are state diagrams of a hierarchal snapshot tree within a remote system shown in FIG. 4, in accordance with an embodiment of the present disclosure. FIG. 6A shows a first state of hierarchal snapshot tree 425 on data storage 420 within remote system 415. In this embodiment, hierarchal snapshot tree 425 includes “V”, which is a read/writable active snapshot and read only snapshot “V” which includes the base data on the remote system before any replication was initiated. “S(0)′”, which represents a previous snapshot received by remote system 415, and “S(0)” which is the active snapshot.

FIG. 6B shows a second state of hierarchal snapshot tree 425 on data storage 420 within remote system 415. In this case, user 450 requested that snapshot 440 be created. Distributed system 405 is enabled to determine where within hierarchal snapshot tree 425 data from snapshot 440 is enabled to be placed. In this embodiment, distributed system 405 determines that snapshot 440 is enabled to be dependent on a previously replicated snapshot “S(0)′” within hierarchal snapshot tree 425 and therefore device 410 can send only differences between snapshot “S(0)′” and snapshot U(0). In this embodiment, remote system 415 received snapshot 440 from device 410. In this case, user 450 requested that snapshot 440 be created at a time before the active snapshot “S(0)” was created. As shown, remote system 415 places data from snapshot 440 as depending from snapshot “S(0)”.

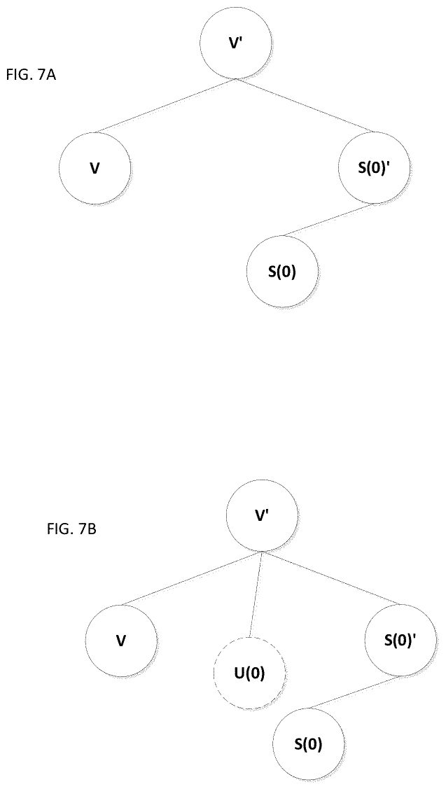

Refer to the example embodiments of FIGS. 4, 7A, and 7B. FIGS. 7A and 7B are state diagrams of a hierarchal snapshot tree within a remote system shown in FIG. 4, in accordance with an embodiment of the present disclosure. FIG. 7A shows a first state of hierarchal snapshot tree 425 on data storage 420 within remote system 415. In this embodiment, hierarchal snapshot tree 425 includes “V”, which is a read/writable active snapshot and read only snapshot “V′” which includes the base data on the remote system before any replication was initiated. “S(0)′”, which represents a previous snapshot received by remote system 415, and “S(0)” which is the active snapshot.

FIG. 7B shows a second state of hierarchal snapshot tree 425 on data storage 420 within remote system 415. In this embodiment, user 450 has created snapshot 440 and has directed distributed system 405 to replicate snapshot 440 to remote system 415. Distributed system 405 queries remote system 415 and determines that snapshot 440 is not based on any snapshot stored within hierarchal snapshot tree 425. As such, distributed system 405 sends the complete data for snapshot 440 to remote system 415 using message 435. Remote system 415 places snapshot 440 as “U(0)” depending from root snapshot “V′”.

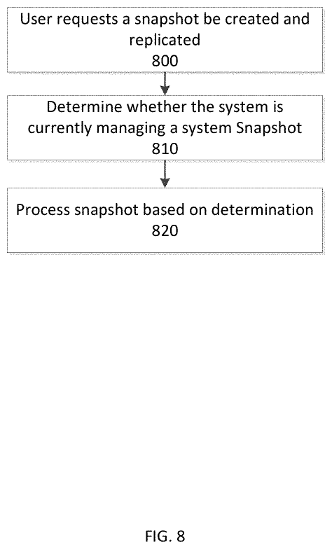

Refer to the example embodiments of FIGS. 4 and 8. FIG. 8 is a simplified flowchart of a method of replication of user initiated snapshots, in accordance with an embodiment of the present disclosure. Data storage system 400 includes distributed system 405 and remote system 415. Distributed system 405 and remote system 415 are in consistency group 430. Distributed system 405 includes device 410. User 450 directs distributed system 405 to create and replicate a snapshot (Step 800). Distributed system 405 determines whether a system snapshot is currently being replicated (Step 810). Upon a negative determination, distributed system 405 creates snapshot 440 and replicates snapshot 440 to remote system 415 using message 435 (Step 820). Upon a positive determination, distributed system 405 creates snapshot 440 and waits to replicate snapshot 440 until replication of system snapshot is completed.

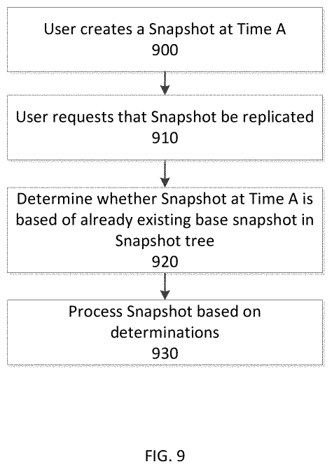

Refer to the example embodiments of FIGS. 4 and 9. FIG. 9 is an alternate simplified flowchart of a method of replication of user initiated snapshots, in accordance with an embodiment of the present disclosure. Data storage system 400 includes distributed system 405 and remote system 415. Distributed system 405 and remote system 415 are in consistency group 430. Distributed system 405 includes device 410. In this embodiment, user 450 directs distributed system 405 to create snapshot 440 at time A (Step 900). User 450 requests that distributed system 405 replicated snapshot 440 to remote system 415 (Step 910). Distributed system 405 determines whether snapshot 440 is based on an already existing base snapshot within hierarchal snapshot tree 425 (Step 920). Upon a positive determination, distributed system 405 sends deltas between snapshot 440 and a found base snapshot to remote system 415 (Step 930). Remote system 415 places data associated with snapshot 440 within hierarchal snapshot tree 425 depending from a base snapshot. Upon a negative determination, distributed system 405 sends the entirety of snapshot 440 to remote system 415 (Step 930). Remote system 415 places received data associated with snapshot 440 within hierarchal snapshot tree 425 dependent from the root of snapshot tree 425.

### General

The methods and apparatus of this invention may take the form, at least partially, of program code (i.e., instructions) embodied in tangible non-transitory media, such as floppy diskettes, CD-ROMs, hard drives, random access or read only-memory, or any other machine-readable storage medium.

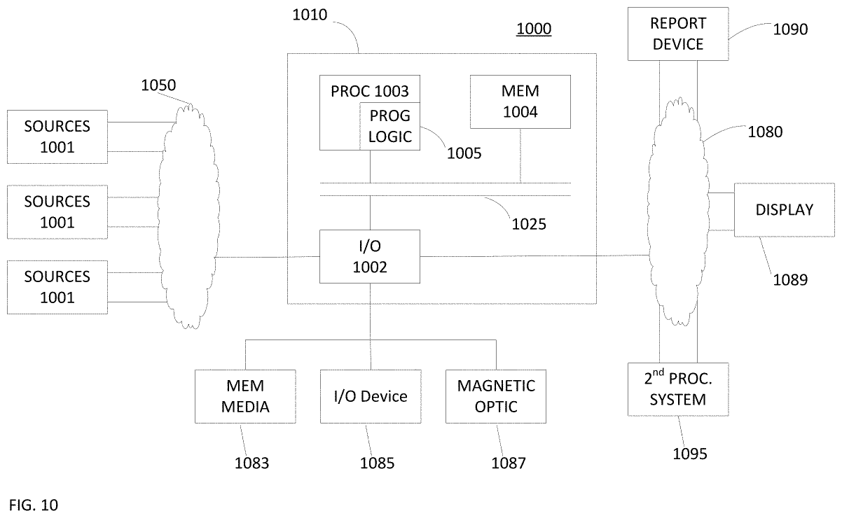

FIG. 10 is a block diagram illustrating an apparatus, such as a computer 1010 in a network 1000, which may utilize the techniques described herein according to an example embodiment of the present invention. The computer 1010 may include one or more I/O ports 1002, a processor 1003, and memory 1004, all of which may be connected by an interconnect 1025, such as a bus. Processor 1003 may include program logic 1005. The I/O port 1002 may provide connectivity to memory media 1083, I/O devices 1085, and drives 1087, such as magnetic drives, optical drives, or Solid State Drives (SSD). When the program code is loaded into memory 1004 and executed by the computer 1010, the machine becomes an apparatus for practicing the invention. When implemented on one or more general-purpose processors 1003, the program code combines with such a processor to provide a unique apparatus that operates analogously to specific logic circuits. As such, a general purpose digital machine can be transformed into a special purpose digital machine.

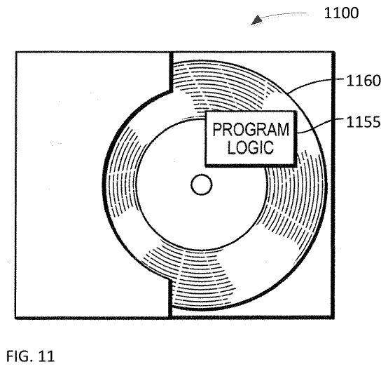

FIG. 11 is a block diagram illustrating a method embodied on a computer readable storage medium 1160 that may utilize the techniques described herein according to an example embodiment of the present invention. FIG. 11 shows Program Logic 1155 embodied on a computer-readable medium 1160 as shown, and wherein the Logic is encoded in computer-executable code configured for carrying out the methods of this invention and thereby forming a Computer Program Product 1100. Program Logic 1155 may be the same logic 1005 on memory 1004 loaded on processor 1003 in FIG. 10. The program logic may be embodied in software modules, as modules, as hardware modules, or on virtual machines.

The logic for carrying out the method may be embodied as part of the aforementioned system, which is useful for carrying out a method described with reference to embodiments shown in, for example, FIGS. 1-11. For purposes of illustrating the present invention, the invention is described as embodied in a specific configuration and using special logical arrangements, but one skilled in the art will appreciate that the device is not limited to the specific configuration but rather only by the claims included with this specification.

Although the foregoing invention has been described in some detail for purposes of clarity of understanding, it will be apparent that certain changes and modifications may be practiced within the scope of the appended claims. Accordingly, the present implementations are to be considered as illustrative and not restrictive, and the invention is not to be limited to the details given herein, but may be modified within the scope and equivalents of the appended claims.

1-18. (canceled)

19. A method of combing a user initiated replication with an automated replication within a distributed data storage system comprising:
periodically providing automatic asynchronous replication between a source storage device and a replication storage device, the source storage device and the replication storage device being part of the distributed data storage system;
storing a hierarchical snapshot tree at the replication storage device, wherein the hierarchical snapshot tree comprises an active snapshot and a read-only base data snapshot;
receiving at the source storage device a user-initiated request to create a snapshot;
determining a base snapshot from which the user initiated snapshot can depend by evaluating the hierarchical snapshot tree; and
storing the user-initiated snapshot at the replication storage device, wherein storing further comprises creating a dependency between the user-initiated snapshot and the base snapshot.

20. The method of claim 19 wherein the hierarchical snapshot tree further comprises one or more replicated snapshots.

21. The method of claim 19 wherein determining a base snapshot from which the user initiated snapshot can depend further comprises comparing a time when the user initiated request to create a snapshot was received with a time when the active snapshot was created.

22. The method of claim 19 wherein upon a negative determination regarding determining a base snapshot from which the user initiated snapshot can depend, creating a second hierarchical snapshot tree corresponding to the user-initiated request to create a snapshot.

23. A system for combing a user initiated replication with an automated replication within a distributed data storage system comprising:
a source storage device and a replication storage device, the source storage device and the replication storage device being part of the distributed data storage system; and
non-transitory, computer-executable program logic configured to perform the following;
periodically providing automatic asynchronous replication between a source storage device and a replication storage device;
storing a hierarchical snapshot tree at the replication storage device, wherein the hierarchical snapshot tree comprises an active snapshot and a read-only base data snapshot;
receiving at the source storage device a user-initiated request to create a snapshot;
determining a base snapshot from which the user initiated snapshot can depend by evaluating the hierarchical snapshot tree; and
storing the user-initiated snapshot at the replication storage device, wherein storing further comprises creating a dependency between the user-initiated snapshot and the base snapshot.

24. The system of claim 23 wherein the hierarchical snapshot tree further comprises one or more replicated snapshots.

25. The system of claim 23 wherein determining a base snapshot from which the user initiated snapshot can depend further comprises comparing a time when the user initiated request to create a snapshot was received with a time when the active snapshot was created.

26. The system of claim 23 wherein upon a negative determination regarding determining a base snapshot from which the user initiated snapshot can depend, creating a second hierarchical snapshot tree corresponding to the user-initiated request to create a snapshot.

27. A computer program product for combing a user initiated replication with an automated replication within a distributed data storage system comprising:
a non-transitory computer readable medium encoded with computer-executable code, the code configured to enable the execution of:
periodically providing automatic asynchronous replication between a source storage device and a replication storage device, the source storage device and the replication storage device being part of the distributed data storage system;
storing a hierarchical snapshot tree at the replication storage device, wherein the hierarchical snapshot tree comprises an active snapshot and a read-only base data snapshot;
receiving at the source storage device a user-initiated request to create a snapshot;
determining a base snapshot from which the user initiated snapshot can depend by evaluating the hierarchical snapshot tree; and
storing the user-initiated snapshot at the replication storage device, wherein storing further comprises creating a dependency between the user-initiated snapshot and the base snapshot.

28. The computer program product of claim 27 wherein the hierarchical snapshot tree further comprises one or more replicated snapshots.

29. The computer program product of claim 27 wherein determining a base snapshot from which the user initiated snapshot can depend further comprises comparing a time when the user initiated request to create a snapshot was received with a time when the active snapshot was created.

30. The computer program product of claim 27 wherein upon a negative determination regarding determining a base snapshot from which the user initiated snapshot can depend, creating a second hierarchical snapshot tree corresponding to the user-initiated request to create a snapshot.
